(19) United States
(12) Patent Application Publication
(10) Pub. No.: US 2020/0096201 A1
(43) Pub. Date: Mar. 26, 2020

(54) CERAMIC BURNER COVER FOR STOVETOPS APPARATUS AND METHOD

(71) Applicant: Gameel Gabriel, Covington, LA (US)

(72) Inventor: Gameel Gabriel, Covington, LA (US)

(21) Appl. No.: 16/141,643

(22) Filed: Sep. 25, 2018

(51) Int. Cl. F24C 7/08; H05B 3/74

(52) U.S. Cl. CPC F24C 7/083; H05B 3/74

(57) ABSTRACT

This present invention provides a ceramic burner cover for gas stovetops. The ceramic burner cover is a solid ceramic cover that is able to removably rest above and cover a gas burner assembly on a stovetop. The ceramic burner cover has a planar ceramic plate and a support member for supporting the plate above the burner assembly. The support member can be formed as a perforated continuous peripheral flange or as a pair of protruding handles secured to outer peripheral edge of the ceramic plate. The burner cover is sized and shaped to cover one or more burner assemblies, while supporting cooking vessels. A metallic insert is incorporated in the burner cover to reduce weight and to more efficiently distribute heat from the burner assembly to a cooking vessel.

### BACKGROUND OF THE INVENTION

The present invention relates to cooking appliances and more particularly to a cooking stove with a single burner or multiple burners. Even more particularly, this invention concerns a ceramic burner cover for stovetops. The ceramic burner cover is a solid ceramic cover that is able to cover a gas burner fixture on a stovetop or an electric spiral heating element. The ceramic cover for stovetops allows stovetop heat to be effectively distributed through solid burners, as heat is efficiently transferred from the heating element directly to the plate. The ceramic burner cover further allows to easily maintain, clean, and replace stovetop cover, while also being useful for the styling of the stovetop.

Gas stovetops come in a variety of styles. These styles include but are not limited to those that have sealed burners and open burners, which are more difficult to clean. The open burner requires a base, through which the gas flame escapes a burner cap removably positioned over the burner base, a drip pan, and a grill that removably fits in the drip pan over the burner base and the cap. The grill supports a cooking vessel, such as a pot, a frying pan, etc. The multi-part burner assembly makes maintenance difficult both by complicating repairs and by being difficult to clean. Although the burner assemblies are typically easy to move, they may be heavy on certain stoves—especially high-end recessed cooktops. Also, as the burner sits in the recess of the stove top, the access is restricted. Furthermore, since the elements of a gas burner assembly are exposed, they have the risk of being damaged as the cook manipulates the cooking vessels.

Some gas stovetops use a spiral heating element that is placed in a recessed stove top. It usually does not have a burner cap although it also uses a grill for supporting a cooking vessel. These types of heating elements are popular in some models and in portable gas stoves used for outdoor activities, such as camping. Spiral burners are conventional in electric stovetops.

Ceramics are low-density, non-metallic materials that although are typically non-conducive to heat are able to withstand very high temperatures. However, together these properties have made ceramics into an attractive material for creating durable and high-quality cookware. Because of the durability of ceramics, they are able to withstand high temperatures while transferring a large enough portion of the heat to heat pans and cookware, and they are also in fact used as cookware. For the ceramic gas burner cover of the present invention, the burner cover may be metal coated with a ceramic coating or may be ceramic in its entirety. Composition of the ceramic cover depends on the weight, cost, and the state of ceramic engineering or ceramography at the time of the production of each ceramic cover.

Current embodiments of stovetop covers do not solve the problem of debris build-up; and in many cases the covers are difficult to remove for cleaning, which makes them an unattractive feature. Some solutions have been offered to solve these problems.

For example, U.S. Pat. No. 6,255,628 for a “Burner Apparatus,” issued on Jul. 3, 2001 to inventor Joseph M. Perrino, provides for a burner apparatus for use with electric or gas ranges which comprises a heating surface and a magnetic means for securing the burner apparatus in position on the cooking range. In another preferred embodiment of the invention, the burner apparatus includes an electric heating element. In another preferred embodiment, the burner apparatus cooperates with a gas heating element.

U.S. Pat. No. 5,994,674 for a “Hob,” issued on Nov. 30, 1999, to inventor Maurice Hugh Carter, provides for a hob comprised of a substantially planar member having apertures defining hotplate regions, a glass-ceramic insert being positioned in each aperture above a radiant heating element. The use of a molded glass insert corresponding to a hotplate region offers several advantages over prior art hobs conventionally comprising a glass-ceramic sheet formed by a flat glass process which extends over a plurality of hotplate regions. Another embodiment consists of a drop-in heating unit for a hob comprising a metal can, a substrate, a resilient annular spacer, a radiant heating element, and a molded glass-ceramic insert. An over-temperature thermal limiter acts to prevent the unit from becoming overheated. A metal compression band extends around a downwardly protruding skirt of the insert, increasing its resistance to shock. The glass-ceramic insert has reinforcing radial spars and a profile which generally has a greater thickness of glass towards its periphery and a generally lesser thickness towards its center, the transition being provided by a curved profile. Such shaping of the insert is said to improve both its transmissive and its conductive properties without a reduction in strength.

U.S. Pat. No. 3,355,574 for an “Electrical Surface Heater with Plural Lamps.” issued on Nov. 28, 1967, to inventor A. T. Bassett, Jr., provides for an electrical surface heater including an infrared transmissive utensil supporting plate, a plurality of spaced apart elongated tubular lamps including an enclosed high temperature resistance element energizable into the infrared range, and a plurality of elongated channel-shaped reflector members located on the sides and beneath said lamps for directing radiant energy therefrom uniformly through the support plate.

U.S. Pat. No. 3,345,498 for an “Infrared Surface Heating Unit,” issued on Oct. 3, 1967 to inventor D. C. Siegla, provides for an infrared surface heating unit including an upper utensil support plate of infrared transmissive material and a bottom reflector plate below the support plate to form a low profile heating unit envelope about a ribbon shaped resistance element formed as a spiral from an input terminal to an output terminal, and wherein the reflector plate includes a polished upper surface having a plurality of up-standing resistance element support posts thereon, each including a vertically directed slotted upper end in which is located a segment of the spirally formed ribbon-shaped resistance element.

U.S. Pat. No. 6,111,229 for a “Cooking Appliance such as a Stove with an Arrangement of a Ceramic Heating Element as a Cooking Zone in a Cutout of a Cooking Surface,” issued on Aug. 29, 2000 to inventor Bernd Schultheis, provides for an arrangement of an electrical heating element as a cooking zone, having as a carrier a ceramic of very high thermal conductivity, in a cutout of a cooking surface comprising glass-ceramic, glass, ceramic, metal, or plastic. The ceramic carrier of the heating element has, above the plane of the cooking surface, a region, by means of which region, the carrier engages over the cutout onto the top of the cooking surface and by means of which region, the carrier rests on the cooking surface by a gasket. The ceramic carrier forms, in the plane of the cooking surface, a further region, by which further region, the carrier is positioned in the cutout at a distance from the end faces of the latter, and, below the plane of the cooking surface, a region having shaped-out portions serves as a bearing for an element which element, with the aid of the cooking surface as an abutment, fixes the heating element in the cutout of the cooking surface.

U.S. Pat. No. 3,830,216 for a “Countertop Heating Apparatus”, as issued on Aug. 20, 1974 to inventor Edwin D. Todd, provides for a domestic cooking unit which includes a drip pan, a planar countertop containing at least one opening, and a heating plate located in the opening and to be heated by a gas burner positioned below the heating plate. The drip pan, countertop, and heating plate are formed from an infrared transmitting, heat-resistant, nonporous, glassceramic material having a low thermal expansion coefficient and a low thermal conductivity. The periphery of the heating plate is spaced inwardly from the periphery of the opening to permit flow of combustion products from the gas burner out from the drip pan and to prevent heat conduction between the heating plate and the countertop. A plurality of spaced supports extends between the drip pan and the heating plate for supporting and positioning the heating plate. The drip pan and the countertop can be formed as an integral unit. The cooking surface of the heating plate is flat and preferably disposed in the same plane as the surface of the countertop thereby presenging a flat area for general use when the unit is not being used for cooking.

U.S. Pat. No. 6,691,699 for a “Cooking Plate,” issued on Feb. 17, 2004 to inventor Gerald Fafet et. al., provides for a hotplate, such as a plate of vitreous ceramic, intended to equip a cooker having at least one gas burner and includes a raised zone intended to cover the gas burner. The raised zone includes orifices.

U.S. Patent Application Publication No. 2012/0318256 for a “Large Capacity Griddle over High BTU Burner.” published on Dec. 20, 2012 by inventor John Mark Chilton et al., discloses a removable large and high capacity griddle for a stovetop for use in conjunction with one or more high BTU output burners. The griddle includes a number of features that allow for the large capacity griddle to be used on a gas range with high capacity burners including a flange extending from a bottom surface of the griddle for locating the griddle on an associated range, and for deflecting and/or otherwise channeling heat from one or more associated burners to regions of the griddle and deflecting heat from adjacent range structures, such as a rear control panel.

U.S. Pat. No. 6,021,774 for a “Cooking Unit, such as a Stove, for Cooking Food.” issued on Feb. 8, 2000 to inventor Martin Taplan et al., provides for a unit with at least one plate made of a material permeable to thermal radiation, such as glass ceramic, glass, ceramic, or a similar material, as a surface for cooking, frying, and/or keeping warm. The unit with at least one plate is on a frame construction with different types of adjustable heat sources distributed underneath and on the plate. Some of the heat sources are distributed under the plate in the form of radiant burners and act indirectly by radiation through the plate. Other heat sources are located above the level of the plate in the form of open atmospheric or atmospheric pressure gas burners and transmit heat directly by producing open flames. The respective heat sources correspond to the cooking, frying, and/or warming positions. The design uses at least one height-equalizing, plate-shaped, modular top part, which sits on a portion of the frame on which the plate lies, and it can be securely fastened to the frame of the unit, and also has heat sources distributed under its plate and acting indirectly by radiation through the plate. The plate-shaped part permits all the cooking, frying, and/or warming positions to lie in a plane of equal height. The plane of equal height is defined by the height of the open, atmospheric gas burners located above the level of the plate or by their corresponding pot grates. The plates form two planes parallel to one another and the height of which plates is different.

U.S. Pat. No. 6,403,930 for a “Modular Radiant Heating Unit Having a Thermally Insulating Gasket and Methods of Assembling Same,” issued on Jun. 11, 2002 to inventor Subhash R. Deo et al., provides for a modular radiant heating unit adapted for installation into a cooktop or the like. In one embodiment, the heating unit comprises an open-topped pan having a bottom and circumferential sidewall defining a flanged upper rim. A thermally insulating support element disposed in the bottom of the pan, and a radiant heating element is disposed in a pattern on the support element. An insulation ring extends around and adjacent to the inner surface of the circumferential sidewall of the pan. A thermally insulating washer-like gasket is disposed atop the insulation ring and the flanged upper rim of the pan. A glass-ceramic cover plate is disposed atop the gasket, such that the gasket enhances the seal between the plate and the pan. The invention also includes methods of assembling a modular radiant heating unit having such a gasket.

U.S. Pat. No. 4,858,590 for a “Flexible Heat Transfer Pad.” issued on Aug. 22, 1989 to inventor Samuel Bailey, provides for a flexible heat transfer pad for positioning on an electrical coil of the heating element on a stove. The pad includes two embossed metal plates with a metal alloy body sandwiched in between the two plates. The center section of the pad defined by the alloy body closely corresponds to the area of the electrical coil. An annular extension around the body includes opposite circular recesses for reinforcement of the pad. The upwardly extending recess forms a drip ring to confine any inadvertent overflow from a pan on the pad. A depending skirt around the drip recess extends over the rim of the heating element and substantially closes the stove opening. A liquid metal alloy body is preferably INDALLOY, a tin and bismuth alloy combination that melts at 281° F. with no appreciable expansion or contraction during phase change or temperature transition. Other alloys or materials with similar properties can be used as a substitute material for the body as long as the melting point is approximately 140° F. or higher. Upon melting at the elevated temperature, the pad becomes flexible so as to conform to the contour of the heating element coil, as well as the bottom of the pan on top. This is said to provide maximum heat transfer efficiency.

Lastly, European Patent Publication No. 401651A1 for a “Cooking Top for Electric Cookers, Cooking Plates and the Like,” published on Dec. 12, 1990 by inventor Armin De Bohnet, discloses a stainless-steel cooking top which is covered outside the heating areas by a stainless-steel plate. The stainless-steel plate is cut away at the heating areas; and at the points above the heating, the glass ceramic disks are set over the cutaway evenly.

While the above-discussed approaches may be beneficial in certain circumstances, there exists a need for a cover for gas stove tops that is efficient, effective, and easy to use to provide protection against damage and a clean environment, all while maintaining suitable heat transfer from the burner for cooking.

### SUMMARY OF THE INVENTION

This invention provides a ceramic burner cover apparatus and method capable of being sized to and fitting to the range of gas or electric cooktops and burners.

It is, therefore, an objective of the present invention to provide a burner cover that is configured to cover one or multiple burner assemblies used in a gas or electric stovetops.

It is further an objective of the present invention to be able to cover the entirety of the gas burners on a recessed stovetop by fitting over the entire recessed portion of the stove.

It is further an objective of the present invention to provide a burner cover that is formed from a material thermally conducive to heat so that heat may transfer from the burner to the cover of the present invention.

It is further an objective of the present invention to provide a burner cover that is durable and capable of withstanding the rigors of daily stovetop use without damage.

It is further an objective of the present invention to provide a burner cover that can be easily placed and removed by a user.

It is further an objective of the invention to provide a burner cover with a ventilation opening to prevent the build-up of heat under the ceramic cover of the present invention.

It is further an objective of the invention to prevent debris build-up under the ceramic cover of the present invention by limiting or grating the size of the vents of the invention and otherwise forming a seal with a stovetop.

The ceramic stovetop cover of the present invention achieves these objectives by being configured to fit in a raised manner over the burner and grill. The ceramic gas stovetop cover has small ventilation holes near the top of the ceramic stovetop cover. The ceramic material should be thermally conductive and resistant to warping or other temperature induced damages.

The ceramic burner cover of the present invention is able to sit over and cover the entire burner assembly including the heating element, base, cap, and grill. This allows the ceramic gas burner cover to prevent debris or spills from entering the recessed area or pit of the stovetop. As a ceramic cover, ceramics having a conductivity and high durability even when heated, and is suitable for reliable heat transfer from the gas burner to the ceramic cover, and thus to whatever cooking vessel is placed on the ceramic cover over the gas burner. The burner cover of the invention can be sized to cover a single burner, more than one burner, or to cover a whole recessed cooktop. By covering the gas burners, the gas burners are protected from damage and are not subject to debris build-up.

The ceramic gas cover of the present invention is easy to remove by simply lifting the ceramic cover off the stovetop. It is further simple to clean by washing. Further, individual gas burner sized ceramic covers allow for some burners on a stovetop to be covered while others remain uncovered according to the user's need. Thus, the ceramic covers are convenient for use in daily life.

### BRIEF DESCRIPTION OF THE DRAWINGS

Reference will now be made to the drawings, wherein like parts are designated by like numerals, and wherein:

FIG. 1 shows a perspective view of individual burner size ceramic gas burner covers each sitting over a burner on a gas stovetop;

FIG. 2 shows a perspective, partially cutaway, view of individual burner size ceramic gas burner covers each sitting over a burner on a gas stovetop;

FIG. 3 shows a perspective view of a large stove size ceramic gas burner cover for recessed cooktops wherein the entire cooktop is recessed, and the ceramic gas burner cover sits over the entire recessed portion of the stovetop covering all burners;

FIG. 4 shows a perspective, partially cutaway, view of a large stove size ceramic gas burner cover for recessed cooktops wherein the entire cooktop is recessed, and the ceramic gas burner cover sits over the entire recessed portion of the stovetop;

FIG. 5 shows a perspective view of individual lay flat ceramic burner covers for individual recessed spiral burners; and

FIG. 6 shows a perspective, partially cutaway, view of individual flat ceramic burner covers lying flat over recessed spiral burners.

### DETAILED DESCRIPTION OF THE INVENTION

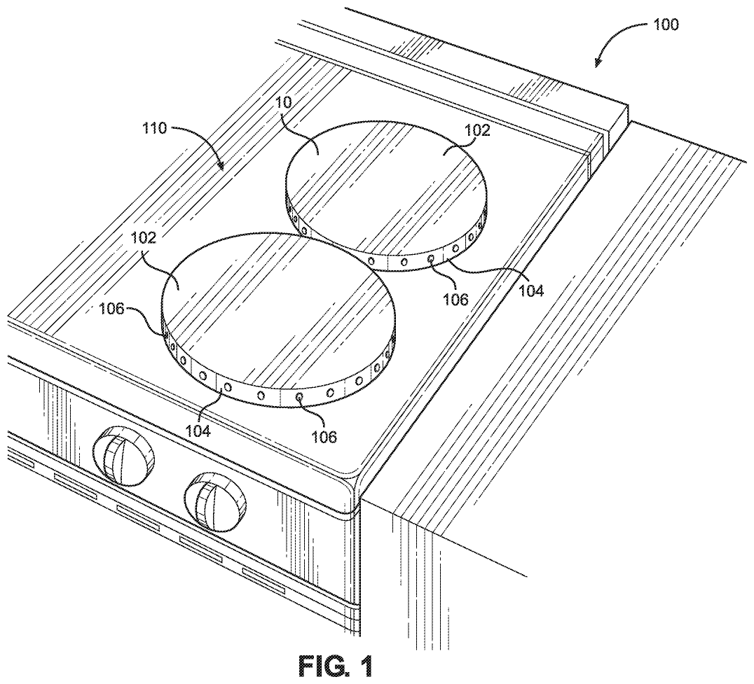

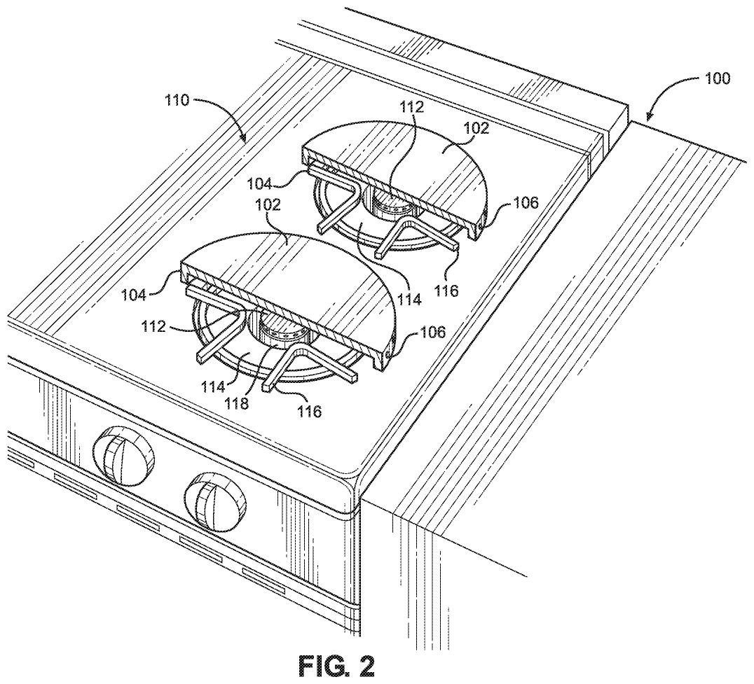

Referring to FIGS. 1 and 2 generally, the figures depict a perspective of the view of the ceramic burner cover for gas stovetop 100 of the present invention on a gas stovetop with individual gas burner grills 116. The ceramic burner cover 10 of the present invention comprises a substantially planar ceramic plate 102 and a downwardly extending circumferential flange or plate skirt 104 integrally connected to outer edge of the plate 102. The flange 104 defines a support surface for the plate 102 when the burner cover 10 rests on the stovetop 100 above the gas burner.

A plurality of spaced apart heat vents 106 is formed in the plate skirt 104 to allow heated gas to escape the burner cover. In an alternate embodiment, not shown in the drawings, the heat vents are formed in the plate 102. The ceramic cover is configured for placement over a gas burner, which has a burner grill 116, gas burner pit 114, a burner base 118 positioned in the pit 114, and burner cap 112 resting on the burner base 118.

The ceramic plate 102 is sized to fit over the burner grill 116 so that the flange 104 comes down vertically from the ceramic plate 102 and rests adjacent to and around the burner grill 116 as shown in FIG. 2. The flange 104 is of a height to hold ceramic plate 102 over the burner grill 116 within about 40 millimeters of burner grill 116 surfaces. In the preferred embodiment of the invention, the flange 104 comes down at a ninety-degree angle from ceramic plate 102 until it meets the stovetop 110. This angle works to prevent debris from falling through the heat vents 106.

As shown in FIG. 1, the heat vents 106 are small hole cut-outs dotting the circumference of the flange 104 and spaced equidistantly from each other. A simple small hole based or small grated heat vent system helps to deny debris from entering under the ceramic cover 10 of the present invention while also providing protection against a build-up of hot air under the ceramic cover 10. In the preferred embodiment of the present invention, the ceramic plate 102 and the ceramic skirt 104 with the heat vents 106 are manufactured as one unit. However, in alternate embodiments of the present invention the ceramic plate 102 and ceramic skirt 104 may have metal inserts to change thermal conductivity properties or may be a metal such as aluminum with a ceramic coating applied, which may further lower the weight and cost of the ceramic burner cover 10. Likewise, in further alternate embodiments of the present invention, the ceramic burner cover 10 may comprise entirely of a metal, such as aluminum, copper, steel, or other metal or like material so long as it is of high thermal conductivity, as an alternative to ceramic.

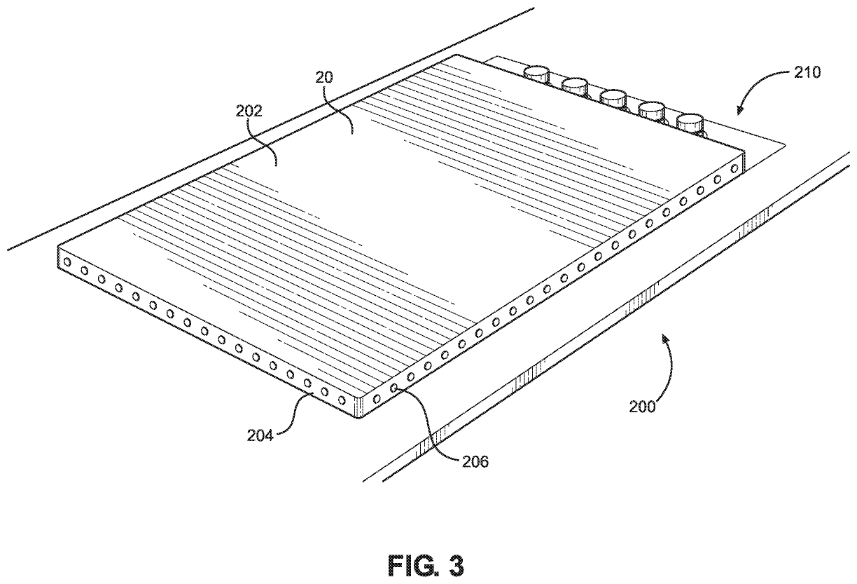

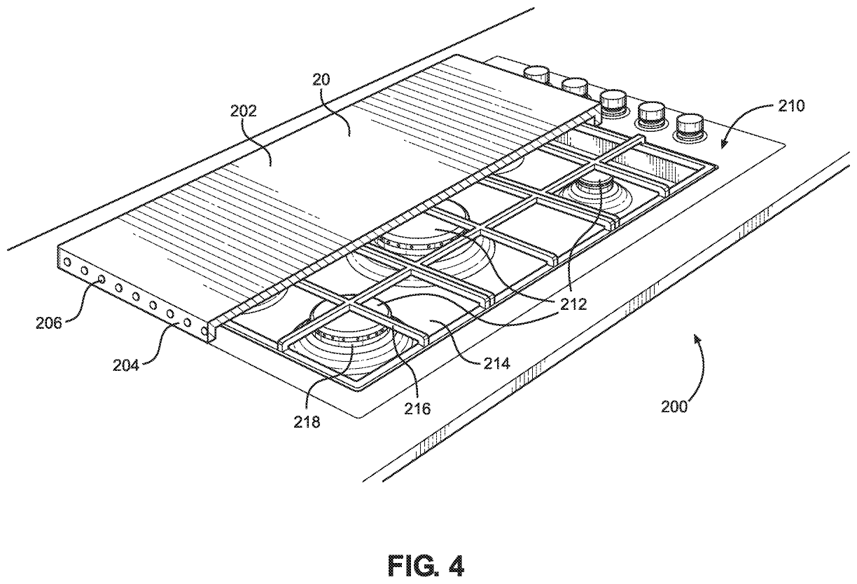

Referring to FIGS. 3 and 4 generally, the figures depict a perspective of the view of the ceramic burner cover 20 for a gas stovetop 200 of the present invention configured to cover more than one burner on the stove 200. In this embodiment, the burner cover 20 is configured as a parallelepiped with a planar plate 202 and downwardly extending peripheral flange 204 integrally secured to an outer peripheral edge of the plate 202. The flange 204 is configured to rest on the top surface 210 of the stovetop 200 in a surrounding relationship over more than one burner. Heat vents 206 are formed in the flange 204 similar to the vents 104 described above. In an alternate embodiment of the present invention, the heat vents are formed in the plate 202. In still another embodiment, the rectangular-shaped cover 20 can be configured to fit in a covering relationship over an individual burner. As shown in FIG. 4, the cover 20 overlaps the burner assembly, which includes a burner grill 216, a burner base 218 resting in a burner pit 214, and burner cap 212 covering the burner base 218.

Ceramic plate 202 is sized to fit over the burner grill 216 so that ceramic skirt 204 comes down vertically from ceramic plate 202 and rests adjacent to and around the burner grill 216 as shown in FIG. 4. Ceramic skirt 204 is of a height to hold ceramic plate 202 over the burner grill 216 within about 40 millimeters of burner grill 216 surfaces. In the preferred embodiment of the invention, the ceramic flange or skirt 204 comes down at a ninety-degree angle from ceramic plate 202 until it meets the stovetop 210. This angle works to prevent debris from falling through the heat vents 206. In some embodiments, the ceramic plate may only cover half of the stovetop and remaining portion be covered by another ceramic plate, with the ceramic skirt for both meeting on top of the stove between the burners.

As shown in FIG. 3, the heat vents 206 are small hole cut-outs dotting the circumference of the ceramic skirt 202. A simple small hole based or small grated heat vent system helps to deny debris from entering under the ceramic burner cover 20 of the present invention while also providing protection against a build-up of hot air under the ceramic cover 202. In the preferred embodiment of the present invention, the ceramic plate 202, ceramic skirt 204, and heat vents 206 are manufactured as one unit. However, in alternate embodiments of the present invention the ceramic plate 202 and ceramic skirt 204 may have metal inserts to change thermal conductivity properties or may be a metal such as aluminum with a ceramic coating applied, which may further lower the weight and cost of the ceramic burner cover 20. Likewise, in further alternate embodiments of the present invention, the ceramic burner cover 20 may comprise entirely of a metal, such as aluminum, copper, steel, or other metal or like material so long as it is of high thermal conductivity, as an alternative to ceramic.

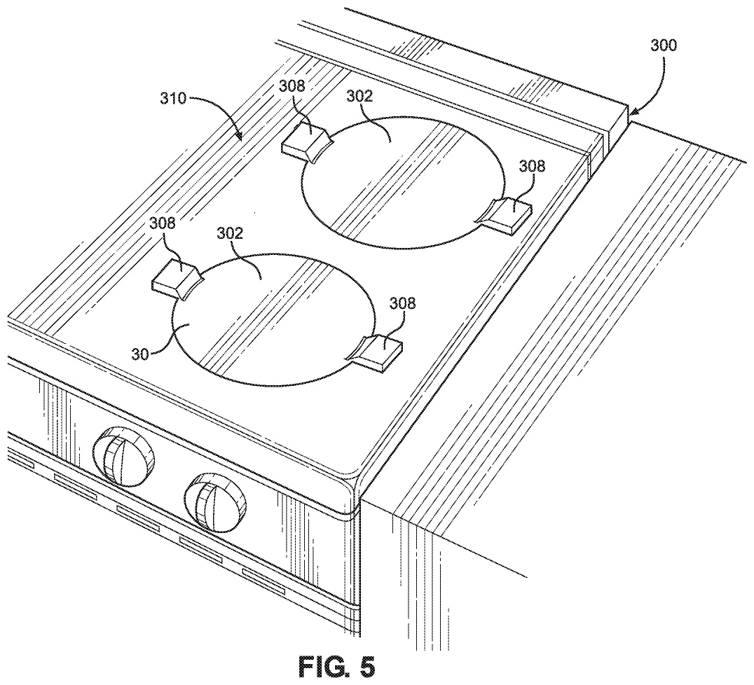

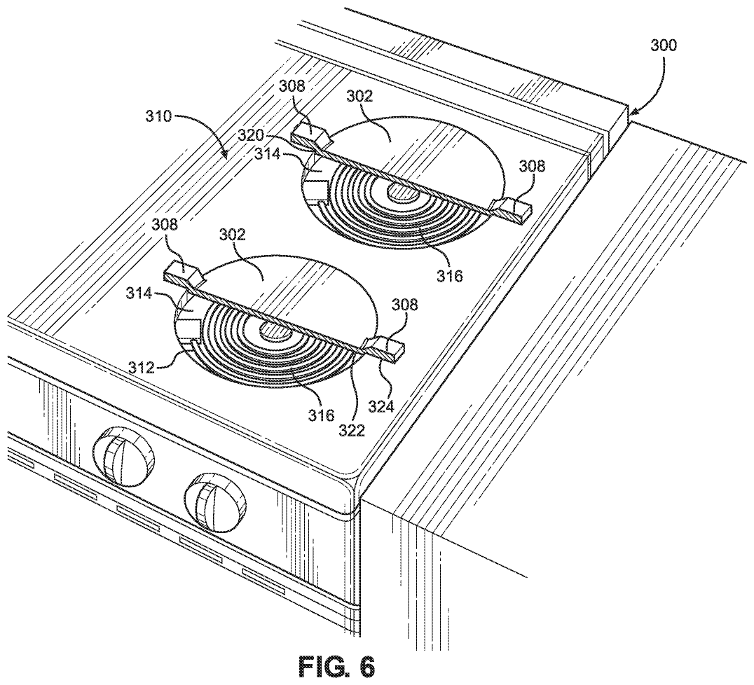

Referring to FIGS. 5 and 6 generally, the figures depict a perspective of the view of the ceramic burner cover 30 for an electric stovetop 300. A heating coil 316 is positioned in a recessed burner pit 312. In this embodiment, the cover 30 comprises a substantially planar circular ceramic plate 302 configured to match the circumference of the recessed burner pit 312. A pair of protrusions 308 is integrally connected to the plate 302 and extend outwardly therefrom. In one aspect of the invention, the protrusions 308 are located on diametrically opposite locations of the cover 30.

An upwardly facing shoulder 320 is formed between a bottom surface 322 of the plate 302 and a bottom surface 324 of the protrusion 308. The shoulder 320 contacts the sidewall of the burner pit 312 and allows the bottom surface 324 of the protrusion 308 to lay flush on a top surface 326 of the stove 310. The protrusions 308 may be rectangular, as shown in the drawings, oval, square, or of a desired configuration. The protrusions 308 function to hold the ceramic cover 30 over the recessed pit 312. As can be seen in FIG. 6, the cover 30 is placed over a stovetop, which houses a coiled burner or surface element 316 positioned over a drip pan 314.

In the preferred embodiment of the ceramic burner cover 30 for the stovetops 30, the ceramic cover 30 is a one-piece unitary formed element. However, in alternate embodiments of the present invention, the ceramic cover 30 may have metal inserts to change thermal conductivity properties or may be a metal such as aluminum with a ceramic coating applied, which may further lower the weight and cost of the ceramic burner cover 30. Likewise, in further alternate embodiments of the present invention, the ceramic burner cover 30 may comprise entirely of a metal, such as aluminum, copper, steel, or other metal or like material so long as it is of high thermal conductivity, as an alternative to ceramic.

Because of the high degree in variability in stove-top ranges, the ceramic burner cover for a stovetop of the present invention may be manufactured in a wide range of sizes or shapes. It will be understood that the cover 30 can be also used for gas stovetops, if desired, and the covers 20 and 30 can be used for electric stovetops. It is preferred however, that the cover used for the gas stovetops be also provided with heat vents.

The ceramic material may be colorized, glossed, or otherwise treated to style the ceramic burner cover 10, ceramic burner cover 20, or ceramic burner cover 30 to be visually attractive to kitchen users, or to be made more durable, or both. Ceramic plate 102, ceramic plate 202, and ceramic plate 302 may have handles attached to the sides of the ceramic plate for easy lifting of the ceramic plate, preferably when cooled. Once the ceramic cover 10, 20, or 30 is properly positioned on the stovetop, the user may place any desired object on the burner for heating.

Many changes and modifications can be made in the ceramic burner cover for gas stovetops according to the present invention without departing from the spirit thereof. I, therefore, pray that my rights to the present invention be limited only by the scope of the appended claims.

I claim:

1. A burner cover for stovetops having at least one burner assembly, the apparatus comprising:
a substantially planar ceramic plate shaped and sized to cover and detachably rest above the at least one burner assembly; and
a support member supporting the ceramic plate on the stovetop.

2. The apparatus of claim 1, wherein the support member comprises a ceramic downwardly extending peripheral flange integrally secured to an outer peripheral edge of the ceramic plate.

3. The apparatus of claim 2, wherein a plurality of spaced-apart heat vents is formed in the peripheral flange.

4. The apparatus of claim 2, wherein the peripheral flange is configured for resting on the stovetop and for supporting the ceramic plate in an elevated position above the at least one burner assembly.

5. The apparatus of claim 1, wherein the burner cover is shaped and sized to operationally fit over more than one burner assembly.

6. The apparatus of claim 2, wherein the burner cover comprises a metallic insert in the ceramic plate, said metallic insert providing additional heat transfer, while reducing weight of the burner cover.

7. The apparatus of claim 6, wherein the ceramic flange comprises a metallic insert.

8. The apparatus of claim 1, wherein the support member comprises a pair of protrusions secured to an outer edge of the ceramic plate, said ceramic plate having a plate bottom surface and each of the protrusions having a protrusion bottom surface, and wherein an upwardly facing shoulder is formed between the plate bottom surface and the protrusion bottom surface.

9. The apparatus of claim 8, wherein the protrusion bottom surface of each of the protrusions is configured to rest on the stovetop and support the ceramic plate above the burner assembly.

10. A method for providing a burner cover for stovetops having at least one burner assembly, the method comprising the steps of:
providing a substantially planar ceramic plate shaped and sized to cover and rest above the at least one burner assembly;
providing a support member for supporting the ceramic plate on the stovetop;
removably positioning the burner cover in a covering relationship above the at least one burner assembly, while the support member rests on the stovetop;
positioning a cooking vessel on the burner cover;
turning on the at least one burner assembly and efficiently transferring evenly distributed heat from the burner assembly to the cooking vessel via the burner cover.

11. The method of claim 10, wherein the support member comprises a ceramic downwardly extending peripheral flange integrally secured to an outer peripheral edge of the ceramic plate.

12. The method of claim 11, wherein a plurality of spaced-apart heat vents is formed in the peripheral flange.

13. The method of claim 11, wherein in use, the peripheral flange rests on the stovetop and supports the ceramic plate in an elevated position above the at least one burner assembly.

14. The method of claim 10, wherein the burner cover is sized and shaped to operationally fit over more than one burner assembly.

15. The method of claim 11, wherein the burner cover comprises a metallic insert in the ceramic plate, said metallic insert providing additional heat transfer, while reducing weight of the burner cover.

16. The method of claim 15, wherein the ceramic flange comprises a metallic insert.

17. The method of claim 10, wherein the support member comprises a pair of protrusions secured to an outer edge of the ceramic plate, said ceramic plate having a plate bottom surface and each of the protrusions having a protrusion bottom surface, and wherein an upwardly facing shoulder is formed between the plate bottom surface and the protrusion bottom surface.

18. The method of claim 17, wherein in use, the protrusion bottom surface of each of the protrusions rests on the stovetop and supports the ceramic plate above the burner assembly.

19. The method of claim 17, wherein the pair of protrusions function as handles for positioning and removing the burner cover.
